(19) United States
(12) Patent Application Publication
(10) Pub. No.: US 2015/0106210 A1
(43) Pub. Date: Apr. 16, 2015

(54) INFORMATION PROCESSING APPARATUS, INFORMATION PROCESSING METHOD, AND INFORMATION PROCESSING PROGRAM

(71) Applicant: Rakuten, Inc., Shinagawa-ku, Tokyo (JP)

(72) Inventor: Sadaaki Emura, Shinagawa-ku (JP)

(73) Assignee: RAKUTEN, INC., Shinagawa-ku, Tokyo (JP)

(21) Appl. No.: 14/360,820

(22) PCT Filed: May 31, 2013
(86) PCT No.: PCT/JP2013/065257

§ 371 Date: May 27, 2014

(30) Foreign Application Priority Data
Sep. 28, 2012 (JP) 2012-218663

(51) Int. Cl. G06Q 30/02

(52) U.S. Cl. CPC G06Q 30/0275
USPC 705/14.71

(57) ABSTRACT

An apparatus, method, and a recording medium for presenting auction information to users who have a strong desire to purchase an item at an appropriate point in time. An information processing server specifies an advertising target auction in which at least one the item name and the item code of a specific item exhibited on an auction is identical, and in which an immediate successful bid is possible at a bid price which has been bid for the auction of the specific item, when a bidder who tries to bid for the auction of the specific item via a web page for receiving bids for an auction is a bidder who has lost the right to win the specific item due to a bid of another bidder, and presents the information on the specified advertising target auction, to bidders who try to bid for the auction of the specific item.

### TECHNICAL FIELD

The present invention relates to a technical field of systems and methods for advertizing auction information to auction users.

### BACKGROUND ART

Conventionally, a system that displays an advertisement for an item exhibited by an exhibitor to users who browse searching results on a keywords set in advance by the exhibitor or items related to the item exhibited by the exhibitor to allow the exhibitor to appeal the item exhibited by the exhibitor in an auction (Internet auction) conducted via a network is known. For example, Patent Literature 1 discloses an auction system that inserts banner advertisements of other auctions related to exhibits that are the same as or related to an exhibit posted on an exhibit homepage in the exhibit homepage.

### PRIOR ART LIST

### Patent Literature

Patent Literature 1: JP 2005-285143 A

### SUMMARY OF THE INVENTION

### Problem to be Solved by the Invention

However, in the conventional technique including Patent Literature 1, since an advertisement for an auction of an item exhibited by an exhibitor is also displayed to users who do not have a strong desired to purchase an item such as users who are collecting item information for prior researches, for example, it cannot be said that the advertisement effect is high.

With the foregoing in view, it is an object of the present invention to provide an information processing apparatus, an information processing method, and a recording medium having an information processing program recorded thereon capable of presenting auction information to users who have a strong desire to purchase an item at an appropriate point in time.

### Means for Solving the Problem

In order to solve the above problem, the invention according to claim 1 is an information processing apparatus comprising:

a display controlling means that displays a page for receiving bids for an auction of a specific item exhibited from bidders, on a terminal apparatus of the bidder; and

a specifying means that specifies other auction in which at least one of the item name and the item code of an item exhibited on the auction, and included in information on the auction of the specific item is identical, and in which an immediate successful bid is possible at a bid price that has been bid for the auction of the specific item, from a storing means that stores information on an auction in which the buyout price is set, when the bidder who tries to bid for the auction of the specific item via the page is a bidder who has lost the right to win the specific item due to a bid of another bidder; and

a presenting means that presents information on the other auction specified by the specifying means, to bidders who try to bid for the auction of the specific item.

According to this invention, information on another auction on which an item having the same item name or the like as an item exhibited on an auction of a specific item is exhibited and which can be auctioned off at a bid price having been bid for the auction of the specific item can be presented to users who have strong desired to purchase the specific item at an appropriate point in time.

The invention according to claim 2 is the information processing apparatus according to claim 1,

wherein when there are a plurality of the other auctions specified by the specifying means, the presenting means presents information on an auction in which the set buyout price is relatively low, preferentially.

According to this invention, another auction in which it is highly expected that an item is browsed or purchased can be effectively presented to bidders who try to bid for the auction of the specific item.

The invention according to claim 3 is the information processing apparatus according to claim 1,

wherein the other auction specified by the specifying means is an auction which is set as an advertising target on condition that an exhibitor pays a predetermined advertising rate, and

when there are a plurality of the other auctions specified by the specifying means, the presenting means presents information on an auction in which the advertising rate of the other auction specified as an advertising target is relatively high, preferentially.

According to this invention, an exhibitor of the other auction can get a profit appropriate for the advertising rate.

The invention according to claim 4 is the information processing apparatus according to claim 1,

wherein the other auction specified by the specifying means is an auction which is set as an advertising target on condition that an exhibitor pays a predetermined advertising rate,

the information processing apparatus further comprising:

an acquiring means that acquires information indicating a probability that an item is purchased by a bidder who tries to bid for the auction of the specific item; and

a resetting means that resets an advertising rate of the other auction set as the advertising target based on the probability indicated by the information acquired by the acquiring means.

According to this invention, the advertising rate can be automatically adjusted so that the exhibitor of the other auction can get a profit appropriate for the advertising rate paid by the exhibitor.

The invention according to claim 5 is the information processing apparatus according to claim 1,

wherein the other auction specified by the specifying means is an auction which is set as an advertising target on condition that an exhibitor pays a predetermined advertising rate,

the information processing apparatus further comprising:

a resetting means that resets an advertising rate of an auction based on the set buyout price when there are a plurality of the other auctions specified by the specifying means.

According to this invention, the advertising rate can be automatically adjusted so that the exhibitor of the other auction can get a profit appropriate for the advertising rate paid by the exhibitor.

The invention according to claim 6 is an information processing method, which is executed by a computer,

the information processing method comprising:

a display controlling step of displaying a page for receiving bids for an auction of a specific item exhibited from bidders, on a terminal apparatus of the bidder; and

a specifying step of specifying other auction in which at least one of the item name and the item code of an item exhibited on the auction, and included in information on the auction of the specific item is identical, and in which an immediate successful bid is possible at a bid price that has been bid for the auction of the specific item, from a storing means that stores information on an auction in which the buyout price is set, when the bidder who tries to bid for the auction of the specific item via the page is a bidder who has lost the right to win the specific item due to a bid of another bidder; and

a presenting step of presenting information on the other auction specified by the specifying step, to bidders who try to bid for the auction of the specific item.

The invention according to claim 7 is an information processing program for causing a computer to function as:

a display controlling means that displays a page for receiving bids for an auction of a specific item exhibited from bidders, on a terminal apparatus of the bidder; and

a specifying means that specifies other auction in which at least one of the item name and the item code of an item exhibited on the auction, and included in information on the auction of the specific item is identical, and in which an immediate successful bid is possible at a bid price that has been bid for the auction of the specific item, from a storing means that stores information on an auction in which the buyout price is set, when the bidder who tries to bid for the auction of the specific item via the page is a bidder who has lost the right to win the specific item due to a bid of another bidder; and

a presenting means that presents information on the other auction specified by the specifying means, to bidders who try to bid for the auction of the specific item.

### Advantageous Effects of the Invention

According to the present invention, information on another auction on which an item having the same item name or the like as an item exhibited on an auction of a specific item is exhibited and which can be auctioned off at a bid price having been bid for the auction of the specific item can be presented to users who have strong desired to purchase the specific item at an appropriate point in time.

### BRIEF DESCRIPTION OF THE DRAWINGS

FIG. 1 is a diagram illustrating an example of a schematic configuration of an auction processing system S according to the present embodiment.

FIG. 2A is a diagram illustrating an example of a schematic configuration of an information processing server SA according to the present embodiment, and FIG. 2B is a diagram illustrating an example of a functional block of a system control unit 4.

FIGS. 3A and 3B are diagrams illustrating examples of contents (entries) registered in various databases.

FIG. 4 is a flowchart illustrating an example of an advertisement presentation determining process of the system control unit 4 of the information processing server SA.

FIG. 5A is a diagram illustrating an example of the screen of a webpage for receiving bids for an auction of a specific item designated by a user, and FIG. 5B is a diagram illustrating an example of the screen of a webpage on which information on an advertising target auction is displayed.

FIGS. 6A to 6C are diagrams illustrating an example (portion) of the information registered in an auction information database 21 at the time of condition determination in step S4, and FIG. 6D is a diagram illustrating an example (portion) of the information registered in the auction information database 21 at the time of priority determination in step S8.

### MODE FOR CARRYING OUT THE INVENTION

Hereinafter, an embodiment of the present invention will be described in detail with reference to the drawings. The embodiment described below is an embodiment when the present invention is applied to an auction processing system.

[1. Overview of Configuration and Function of Auction Processing System]

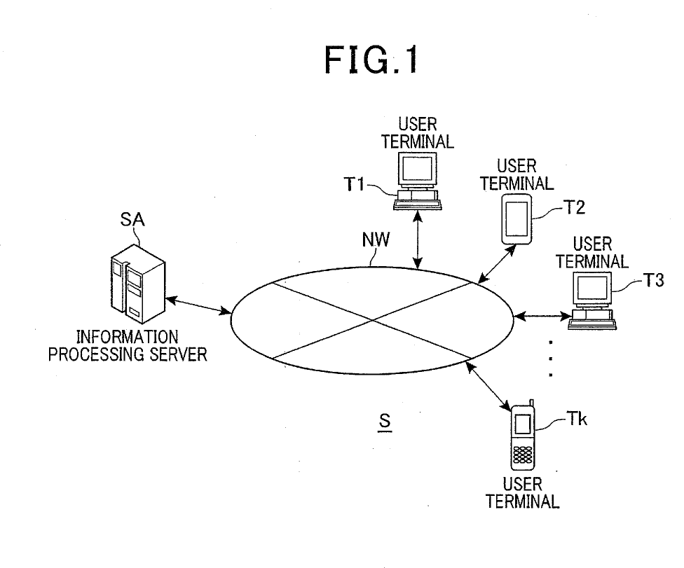

First, an overview of the configuration and function of an auction processing system S according to an embodiment of the present invention will be described with reference to FIG. 1. FIG. 1 is a diagram illustrating an example of a schematic configuration of the auction processing system S according to the present embodiment. As illustrated in FIG. 1, the auction processing system S includes a plurality of user terminals Tn (n=1, 2, 3, . . . , k) and an information processing server SA. The user terminal Tn and the information processing server SA are connected to a network NW. The network NW is constructed, for example, by the Internet, a private communication line (e.g., a community antenna television (CATV) line), a mobile communication network (including a base station and the like), a gateway, and the like.

The information processing server SA is an information processing apparatus that executes various processes related to an auction conducted via the network NW and provides an auction site to the user terminal Tn. The information processing server SA transmits a page (e.g., a webpage) related to an auction to the user terminal Tn (example of a terminal apparatus) of an auction user in response to a request from the user terminal Tn having accessed the auction site to thereby display the page to the user terminal Tn. An example of the auction user includes an exhibitor (auction exhibitor) who exhibits an item on an auction and a bidder (auction bidder) who makes a bid on an auction of the exhibited item.

Software such as a web browser is installed in the user terminal Tn used by the auction user. The user terminal Tn displays the acquired webpage acquired by transmitting a request to the information processing server SA via the web browser on a display. The user can exhibit an item on an auction or make a bid on the auction via the webpage displayed on the display. A personal computer, a mobile information terminal such as a personal digital assistant (PDA) or a smartphone, a mobile phone, a mobile game machine, or the like, for example, is used as the user terminal Tn.

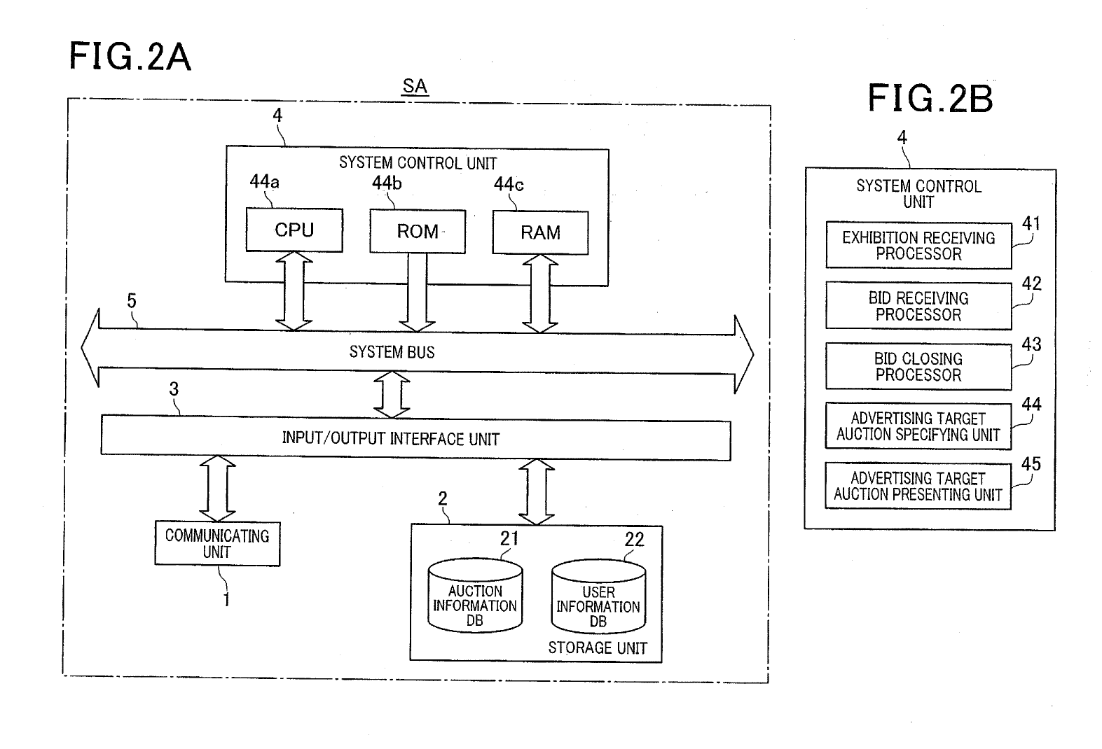

FIG. 2A is a diagram illustrating an example of a schematic configuration of the information processing server SA according to the present embodiment. As illustrated in FIG. 2A, the information processing server SA includes a communicating unit 1, a storage unit 2, an input/output interface unit 3, and a system control unit 4. The system control unit 4 and the input/output interface unit 3 are connected by a system bus 5. The communicating unit 1 is configured to connect to the network NW to control the communication state with the user terminal Tn.

The storage unit 2 is configured as a hard disk drive or the like, for example, and stores various programs such as an operating system and a bid closing processing program (including an information processing program of the present invention). The information processing program may be downloaded from a predetermined server or the like via the network NW and may be recorded on a recording medium such as a compact disc (CD) or a digital versatile disc (DVD) and read. Moreover, the storage unit 2 stores structured document (e.g., a hypertext markup language (HTML) or XHTML document) files, image data, and the like that for the webpage displayed to the user terminal Tn. Further, the storage unit 2 stores an auction information database (DB) 21 in which information of a plurality of auctions of exhibited items is registered for each auction and a user information database (DB) 22 in which user information of users who have registered as auction users is registered for each user. The auction information database 21 and the user information database 22 may be stored in another server other than the information processing server SA.

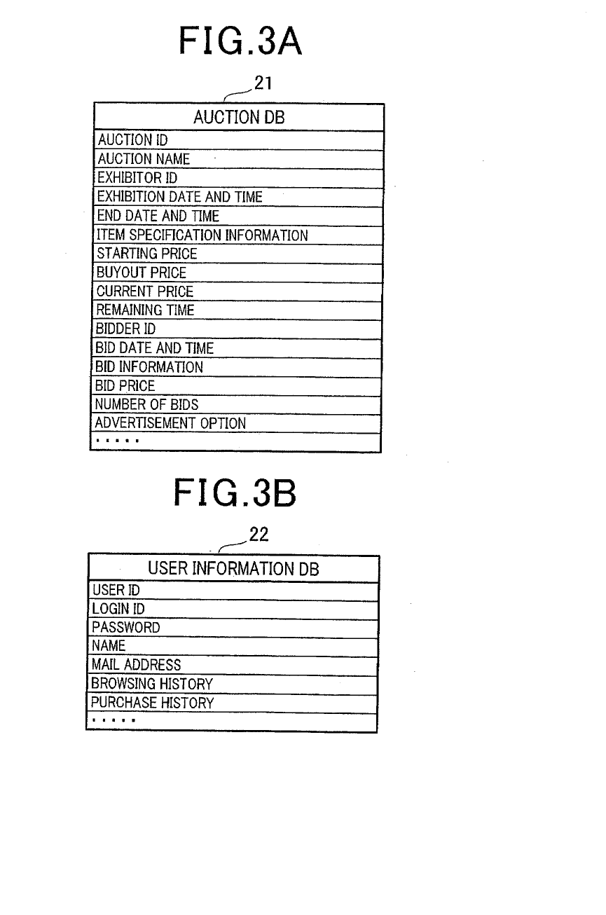

FIGS. 3A and 3B are diagrams illustrating examples of contents (entries) registered in various databases. In the auction information database 21 illustrated in FIG. 3A, information such as an auction ID, an auction name, an exhibitor ID, an exhibition date and time, an end date and time, item specification information, a starting price, a buyout price (buy-it-now price), a current price, a remaining time, a bidder ID, a bid date and time, a bid price, the number of bids, and an advertisement option is registered in association with each auction. When an exhibited item is auctioned off, the contract price of the item and a destination to the successful bidder are registered in the auction information database 21. Moreover, although not illustrated in FIG. 3A, information such as a delivery method and a payment method is also included in the auction information database 21. The detailed information (information such as item description) of the exhibited item may be registered in the auction information database 21 in association with the auction ID and may be registered in an item information database (not illustrated) provided separately from the auction information database 21 in association with the auction ID. Further, information updated until the end date and time such as a current price and a remaining time among the respective pieces of information registered in the auction information database 21 may be registered in a database (not illustrated) provided separately from the auction information database 21 in association with the auction ID.

Here, the auction ID is identification information for identifying an auction and is different from auction to auction. The auction name is the name of an auction itself that is arbitrarily assigned by an exhibitor and is made up of an item name related to an exhibit, a character string (which may include symbols and numbers) that includes the characteristics thereof, and the like. The exhibitor ID is identification information for identifying an auction exhibitor, and for example, is a user ID of the exhibitor. The exhibition date and time is the date and time when an item was exhibited by an auction exhibitor. The end date and time is the date and time when an auction is ended, and for example, is set when an auction exhibitor designates the end date and time on a webpage. The item specification information is information that can specify an exhibited item, and for example, is set when an auction exhibitor designates the item specification information on a webpage. Examples of the item specification information include an item name of an item exhibited on the auction, an item code of the exhibited item, an item category of the exhibited item, and an item image of the exhibited item. The item name is made up of a character string (which may include symbols and numbers). The item name and the auction name may sometimes be the same. Examples of the item code include a model number (e.g., which is set by the items' manufacturer) of the item, an item number (the number described below a barcode assigned to an item, for example) of the item, and a JAN code. The item specification information may be sometimes made up of the item name only or the item code only.

The buyout price is a price at which an item can be auctioned off (bought out) immediately earlier than the closing time of an auction, and is set when an auction exhibitor designates the buyout price on a webpage. In other words, the buyout price indicates a price at which one who makes the earliest bid can make a successful bid. The starting price is the price at the start of an auction, and for example, is set when an auction exhibitor designates the starting price on a webpage. The current price is the highest bid price and is updated whenever bidders make a bid. When there is no bid, the current price is the starting price. The remaining time is the time remaining before the closing time of an auction.

The bidder ID is identification information for identifying a bidder of an auction, and for example, is a user ID of the bidder. The bid date and time is the date and time when a bidder of an auction made a bid on the auction. The bid price is the price that a bidder of an auction has designated when making a bid on an auction. When a plurality of bidders makes a bid on an auction, the bidder ID, the bid date and time, and the bid price of each bidder are registered in association with the auction ID of the auction. The number of bids is the number of bidders of an auction. The advertisement option is information indicating whether the auction is set as an advertising target. For example, when an auction exhibitor designates an auction as an advertising target on a webpage on condition that the auction exhibitor pays a predetermined advertising rate (which may be a point), the auction is set as an advertising target and an advertisement option “O” is registered. Information on the auction (hereinafter referred to as an “advertising target auction”) set as the advertising target is presented to bidders who try to bid for auctions other than the advertising target auction under the conditions described later. The advertising rate can be set in stages from a low advertising rate to a high advertising rate based on the instructions of the exhibitor of the advertising target auction. For example, the advertising rate is set to an integer multiple (1×, 2×, . . . , and the like) of the unit advertizing price (the lowest price of the advertising rate). The higher the advertising rate of the advertising target auction, the more preferentially the information on the advertising target auction is presented to bidders who make bids on auctions other than the advertising target auctions as an advertisement.

In the user information database 22 illustrated in FIG. 3B, information such as a user ID, a login ID, a password, a name, a mail address, a browsing history, and a purchase history is registered in association with each user.

Herein, the user ID is identification information for identifying a user who has registered as an auction user. The user who has registered as an auction user can exhibit an item or make a bid on an auction. The login ID and the password are authentication information used when a user logs in to exhibit an item or make a bid on an auction, for example.

The browsing history includes information such as a URL of a webpage (e.g., a webpage on which item information is posted in an auction site or a shopping site) that the user browses, the item name or the item code of the item posted on the webpage, and a browsing date and time (the date and time of browsing). The browsing history is registered when the webpage is displayed to the user terminal Tn according to an operation of the logged-in user or when the information on the webpage is transmitted to the user in response to a request from the user terminal Tn. Alternatively, the browsing history stored by the web browser of the user terminal Tn may be transmitted to and registered in the information processing server SA during logging of the user of the user terminal Tn. The browsing history may be registered in a browsing history database provided separately from the user information database 22 in association with the user ID.

The purchase history includes information such as the item name or the item code of an item that a user has purchased in an auction site or a shopping site, the number of purchased items, a purchase price, and a purchase date and time (the date and time of purchase). The purchase history may include information indicating the probability (conversion ratio) that an item is purchased by a user. The probability (conversion ratio) that an item is purchased indicates the ratio (the ratio of the number of purchased items to the number of browsed items) of the number of items purchased by the user to the number of items browsed in the past by the user on a webpage, for example. Such a probability (conversion ratio) can be calculated based on the browsing history and the purchase history of the user, for example. The purchase history may be registered in a purchase history database provided separately from the user information database 22 in association with the user ID.

The input/output interface unit 3 is configured to perform interfacing processes between the communicating unit 1 and the storage unit 2, and the system control unit 4.

The system control unit 4 is configured to include a central processing unit (CPU) 4a, a read only memory (ROM) 4b, a random access memory (RAM) 4c, and the like. FIG. 2B is a diagram illustrating an example of a functional block of the system control unit 4. The system control unit 4 as a computer executes various processes related to an auction according to the bid closing processing program stored in the storage unit 2. With such a process, as illustrated in FIG. 2B, the system control unit 4 functions as an exhibition receiving processor 41, a bid receiving processor 42, an bid closing processor 43, an advertising target auction specifying unit 44, an advertising target auction presenting unit 45, and the like. The exhibition receiving processor 41 is an example of a resetting means of the present invention. The bid receiving processor 42 is an example of a display controlling means of the present invention. The advertising target auction specifying unit 44 is an example of a specifying means of the present invention. The advertising target auction presenting unit 45 is an example of a presenting means and an acquiring means of the present invention.

The exhibition receiving processor 41 executes processes of providing an exhibition on an auction to the user terminal Tn of a webpage for receiving the exhibition, acquiring exhibition information from the user terminal Tn of an auction exhibitor, setting various parameters, setting an advertising rate, setting an auction ID, and registering exhibition information. Here, the exhibition information includes an exhibitor ID, an exhibition date and time, an end date and time, item specification information, a starting price, a buyout price, and an advertisement option, for example. The buyout price is included in the exhibition information when it is designated by the auction exhibitor. In setting of various parameters, a current price is set for the auction based on a starting price (that is, the starting price is set as the current price). Moreover, when the buyout price is included in the exhibition information, the buyout price is set for the auction. Further, the remaining time is set for the auction based on the end date and time. In this manner, a unique auction ID is set for the exhibition information that includes the respective parameters set for the auction, and the exhibition information and the auction ID are registered in the auction information database 21 in association.

The bid receiving processor 42 executes processes of providing bids on an auction to the user terminal Tn of a webpage for receiving the bids, acquiring bid information from the user terminal Tn of the auction bidder, registering the bid information, and registering the number of bids. For example, the bid information includes information such as an auction ID, a bidder ID, a bid date and time, and a bid price of a bidding target auction. The bid information is registered in the auction information database 21 in association with an auction ID identical to the auction ID included in the bid information. The bid price registered at this time is a bid price (highest bid price) that is highest at the time of registration.

The bid closing processor 43 executes a bid closing process when the bid price included in the bid information is equal to or higher than a buyout price or the remaining time reaches “0.” In the bid closing process, information indicating that an item has been auctioned off is notified to a successful bidder (bidder who is the first one having designated a bid price equal to or higher than the buyout price or a bidder who has designated the highest bid price when the remaining time reached “0”) and an auction exhibitor.

The advertising target auction specifying unit 44 specifies an advertising target auction (another non-ended auction) of which at least one the item name and the item code is identical to the item name and/or the item code of a specific item exhibited on an auction and which can be auctioned off at a bid price which has been bid for the auction of the specific item from the auction information database 21 when a bidder who tries to bid for an auction of the specific item via a webpage for receiving bids for an auction is a bidder who has lost the right to win the specific item due to a bid of another bidder.

The advertising target auction presenting unit 45 presents information on the advertising target auction specified by the advertising target auction specifying unit 44 to bidders who try to bid for an auction of the specific item.

[2. Operation of Auction Processing System]

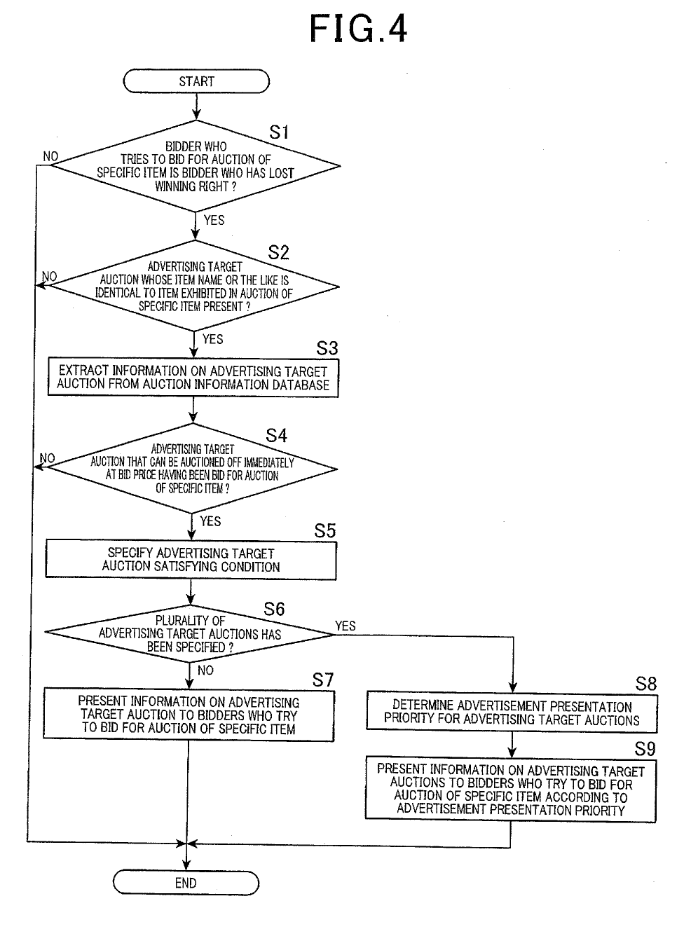

Next, the operation of the auction processing system S according to the present embodiment will be described with reference to FIG. 4 and other figures. In the following description, it is assumed that an advertising target auction in which a buyout price is set is registered in the auction information database 21. FIG. 4 is a flowchart illustrating an example of an advertisement presentation determining process of the system control unit 4 of the information processing server SA.

When the user of the user terminal Tn having accessed the information processing server SA via the network NW performs a login process and then designates a specific item desired by the user on a webpage (e.g., a webpage for selecting items exhibited on an auction) displayed on the user terminal Tn, the system control unit 4 of the information processing server SA transmits a request for acquisition of a webpage for receiving bids for an auction of the specific item to the information processing server SA. Upon receiving the webpage acquisition request, the system control unit 4 of the information processing server SA transmits the webpage for receiving bids for the auction of the specific item to the user terminal Tn and displays the webpage using a web browser.

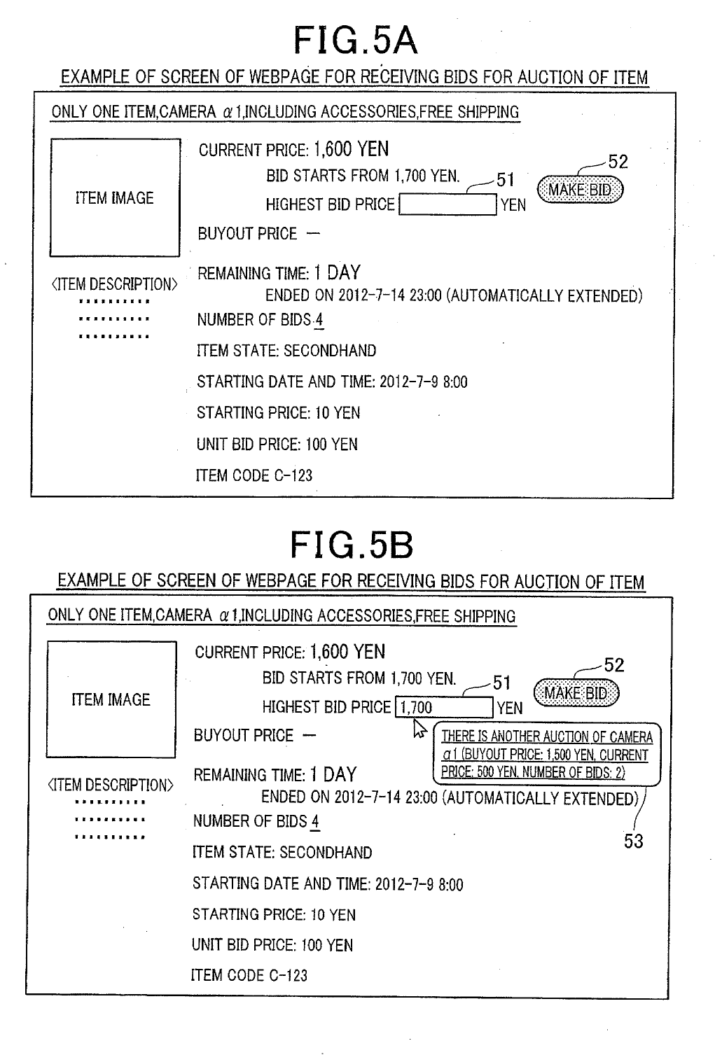

FIG. 5A is an example of the screen of the webpage for receiving bids for an auction for a specific item designated by a user. In such a display state, when the user of the user terminal Tn operates an operation unit to perform an active bidding action, an advertisement presentation determination request for an advertising target auction is transmitted to the information processing server SA. Examples of the active bidding action include (a) selecting (e.g., clicking with a mouse or tapping a finger or the like) a bid price input field 51, (b) inputting (e.g., inputting using a keyboard or a number pad) numbers in a bid price input field 51, and (c) inputting a highest bid price in the bid price input field 51 and moving a mouse over a make bid button 52 (e.g., moving a mouse icon on the make bid button 52). Alternatively, the active bidding action may involve designating a specific item desired by the user on a webpage for selecting items exhibited on an auction, for example. In this case, an acquisition request for the webpage is included in the advertisement presentation determination request.

Upon receiving the advertisement presentation determination request, the system control unit 4 of the information processing server SA starts the process illustrated in FIG. 4. When the process illustrated in FIG. 4 starts, first, the advertising target auction specifying unit 44 of the system control unit 4 refers to the auction information database 21 to determine whether the bidder who tries to bid for an auction of the specific item via a webpage for receiving bids for the auction of the specific item is a bidder who has lost the right to win the specific item due to a bid of another bidder (step S1). Here, the bidder who tries to bid for the auction of the specific item is the user of the user terminal Tn that has issued the advertisement presentation determination request and the user of which the user ID is specified by the login process. The bidder who has lost the successful bid right is a bidder who has bid for the auction of the specific item at a certain bid price, and however, after the bidding, another bidder has won the auction at a highest bid price higher than the bid price. For example, when the bid price associated with the user ID of the user specified by the login process in the auction information database 21 is lower than the current price, the user is determined to be the bidder who has lost the successful bid right (that is, the condition is determined to be satisfied).

When it is determined that the bidder who tries to bid for the auction of the specific item is the bidder who has lost the right to win the specific item due to a bid of another bidder (step S1: YES), the flow proceeds to step S2. When it is determined that the bidder is not the bidder who has lost the right to win the item (step S1: NO), the process illustrated in FIG. 4 ends, and another process (e.g., a bid receiving process or the like) is performed.

In step S2, the advertising target auction specifying unit 44 of the system control unit 4 refers to the auction information database 21 to determine whether a non-ended advertising target auction (that is, an auction in which a buyout price is set and which is set as an advertising target) of which at least one of the item name and the item code is identical to the item name and/or the item code of the item exhibited on the auction of the specific item is present. For example, when an advertising target auction of which the exhibition information includes the item code identical to the item code of the item exhibited on the auction of the specific item is registered in the auction information database 21, it is determined in step S2 that the advertising target auction is present (step S2: YES), and the flow proceeds to step S3. On the other hand, when it is determined that the advertising target auction is not present (step S2: NO), the process illustrated in FIG. 4 ends, and another process (e.g., a bid receiving process or the like) is performed.

In step S3, the advertising target auction specifying unit 44 of the system control unit 4 extracts information (e.g., item specification information, a buyout price, a current price, the number of bids, and the like) of the advertising target auction which has been determined to satisfy the condition in step S2 from the auction information database 21.

Subsequently, the advertising target auction specifying unit 44 of the system control unit 4 determines whether an advertising target auction that can be auctioned off immediately at the current bid price having been bid for the auction of the specific item is present in the advertising target auctions extracted in step S3 (step S4). For example, the current price (acquired from the auction information database 21) of the auction of the specific item is compared with the buyout price (extracted in step S3) of the advertising target auction. When an advertising target auction of which the buyout price is equal to or lower than the current price is present, it is determined that an advertising target auction that can be auctioned off immediately at the current bid price is present (that is, it is determined that the condition is satisfied).

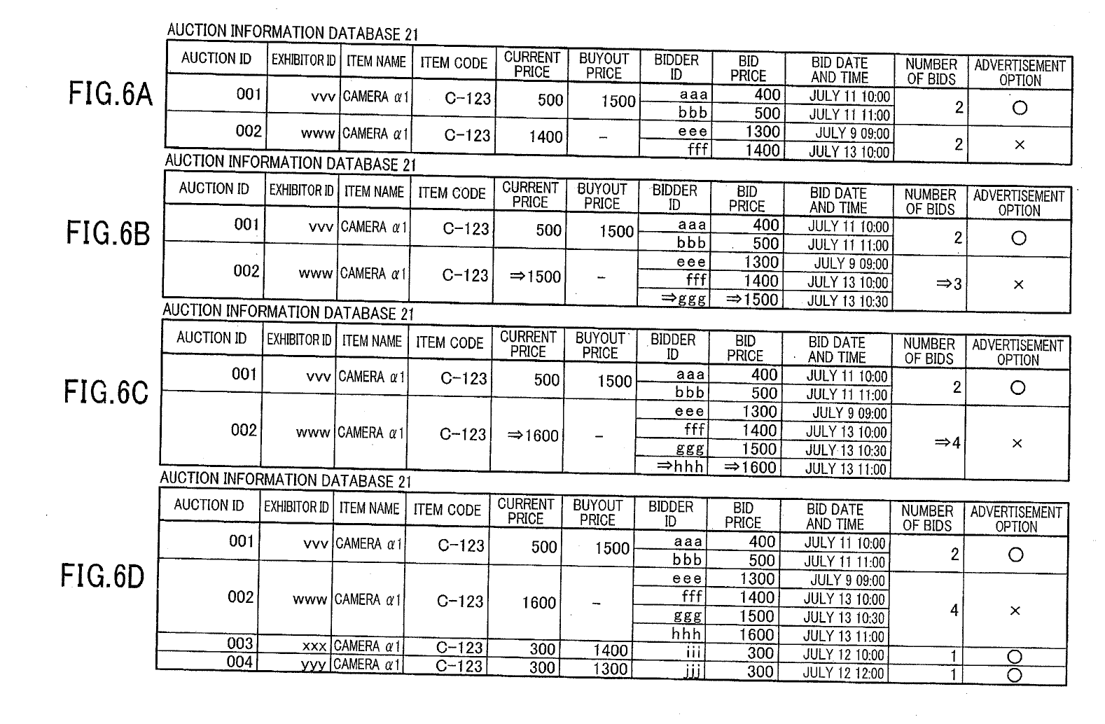

FIGS. 6A to 6C are diagrams illustrating an example (portion) of the information registered in the auction information database 21 during condition determination in step S4. In the example illustrated in FIGS. 6A to 6C, information associated with an auction ID “001” is information on an advertising target auction, and information associated with an auction ID “002” is information on the auction of the specific item. In the example illustrated in FIG. 6A, when a bidder (bidder having lost a successful bid right) corresponding to a bidder ID “eee” in the auction of a specific item corresponding to the auction ID “002” tries to bid at a bid price of “1500 yen,” since the buyout price “1500 yen” of the advertising target auction corresponding to the auction ID “001” is higher than the current price “1400 yen” of the auction corresponding to the auction ID “002,” the condition of step S4 is not satisfied. This is because the bidder who has lost the successful bid right only has to bid for the auction of the specific item at a bid price of “1500 yen” and there is a rare need to present the information on the advertising target auction. On the other hand, in the example illustrated in FIG. 6B, when a bidder (bidder who has lost a successful bid right) corresponding to a bidder ID “eee” or “fff” in the auction of the specific item corresponding to the auction ID “002” tries to bid at a bid price of “1600 yen,” since the buyout price “1500 yen” of the advertising target auction corresponding to the auction ID “001” is the same as the current price “1500 yen” of the auction corresponding to the auction ID “002,” the condition of step S4 is satisfied. Moreover, in the example illustrated in FIG. 6C, when a bidder (bidder who has lost a successful bid right) corresponding to the bidder ID “eee,” “fff,” or “ggg” in the auction of the specific item corresponding to the auction ID “002” tries to bid at a bid price of “1700 yen,” since the buyout price “1500 yen” of the advertising target auction corresponding to the auction ID “001” is lower than the current price “1600 yen” of the auction corresponding to the auction ID “002,” the condition of step S4 is satisfied.

In step S4, the advertising target auction specifying unit 44 may be configured to determine whether an advertising target auction that can be auctioned off immediately at a bid price at which a bidder has already bid for the auction of the specific item is present in the advertising target auctions extracted in step S3. In the example illustrated in FIG. 6C, when a bidder corresponding to the bidder ID “ggg” in the auction of the specific item corresponding to the auction ID “002” tries to bid at a bid price “1700 yen,” since the bidder has already bid for the auction of the specific item at the same bid price as the buyout price “1500 yen” of the advertising target auction of the auction ID “001,” the condition of step S4 is satisfied. Since the bidder of the bidder ID “ggg” has already committed to pay the buyout price (1500 yen) for the item, when the information on the advertising target auction is presented to such a bidder, it is highly expected that the item exhibited on the advertising target auction will be purchased at the buyout price, and thus, the advertisement effect can be increased.

When it is determined that an advertising target auction that can be auctioned off immediately at the current bid price having been bid for the auction of the specific item is present in the advertising target auctions extracted in step S3 (step S4: YES), the flow proceeds to step S5. On the other hand, when it is determined that an advertising target auction that can be auctioned off immediately at the current bid price having been bid for the auction of the specific item is not present in the advertising target auctions extracted in step S3 (step S4: NO), the process illustrated in FIG. 4 ends and another process (e.g., a bid receiving process or the like) is performed.

In step S5, the advertising target auction specifying unit 44 of the system control unit 4 specifies the advertising target auction that has been determined in step S4 to satisfy the condition (e.g., the advertising target auction is specified by an auction ID). Subsequently, the advertising target auction specifying unit 44 of the system control unit 4 determines whether a plurality of advertising target auctions has been specified in step S5 (step S6). When it is determined that a plurality of advertising target auctions has not been specified (that is, only one advertising target auction has been specified) (step S6: NO), the flow proceeds to step S7. When it is determined that a plurality of advertising target auctions has been specified (step S6: YES), the flow proceeds to step S8.

In step S7, the advertising target auction presenting unit 45 of the system control unit 4 executes a process of presenting information (e.g., item specification information, a buyout price, a current price, the number of bids, and the like) of the advertising target auction specified in step S5 to bidders (that is, bidders who have lost the successful bid right) who try to bid for the auction of the specific item. In this presenting process, the advertising target auction presenting unit 45 transmits the information on the advertising target auction to the user terminal Tn and displays the information using a web browser in a state where the webpage for receiving bids for the auction of the specific item is displayed, for example. The information on the advertising target auction is presented to the bidders by displaying the information without refreshing the entire webpage using Ajax, for example.

FIG. 5B is a diagram illustrating an example of the screen of a webpage on which the information on the advertising target auction is displayed. In the example illustrated in FIG. 5B, an item name, a buyout price, a current price, and the number of bids are displayed as a separate pop-up window 53 as the information on the advertising target auction. In this way, bidders who try to bid for the auction of the specific item can understand before bidding for the specific item that there is another advertising target auction on which the same item as the specific item is exhibited. Further, in the example illustrated in FIG. 5B, a link (URL) to a webpage for receiving bids for the advertising target auction is set in the information on the advertising target auction. When the link is selected (e.g., clicked with a mouse or tapped with a finger or the like) by a bidder who tries to bid for the auction of the specific item, the system control unit 4 transmits the webpage for receiving bids for the advertising target auction to the user terminal Tn so as to be displayed by a web browser (page transition). In this way, the bidder who tries to bid for the auction of the specific item can quickly bid for the presented advertising target auction instead of the auction of the specific item. The information on the advertising target auction may be presented by other methods. For example, the information on the advertising target auction may be transmitted to a mail address registered in the user information database 22 in association with the user ID of the bidder who tries to bid for the auction of the specific item.

In step S8, the advertising target auction presenting unit 45 of the system control unit 4 determines the advertisement presentation priority of at least some of the plurality of advertising target auctions specified in step S5. The advertisement presentation priority is a parameter indicating which advertising target auction among the plurality of advertising target auctions will be presented preferentially to the user. The higher the advertisement presentation priority of the advertising target auction, the more preferentially the advertising target auction is presented to the bidders who try to bid for the auction of the specific item. For example, the advertisement presentation priority is expressed, for example, by “Large,” “Medium,” and “Small” (or by numbers), and the advertising target auction of which the priority is “Large” is presented more preferentially than other advertising target auctions. The priority may not be determined for all advertising target auctions specified in step S5 (that is, the priority may be determined for some advertising target auctions). An advertising target auction of which the priority is not determined is presented later than the advertising target auction of which the priority is determined.

For example, the advertising target auction presenting unit 45 determines that an advertisement presentation priority of “Large” is determined for an auction of which the set buyout price is relatively low among the plurality of advertising target auctions specified in step S5. FIG. 6D is a diagram illustrating an example (portion) of the information registered in the auction information database 21 during priority determination in step S8. In the example illustrated in FIG. 6D, the information associated with the auction IDs “001,” “003,” and “004” is information on the advertising target auctions, and the information associated with the auction ID “002” is information on an auction of a specific item. In the example illustrated in FIG. 6D, the buyout price set to the advertising target auction corresponding to the auction ID “001” is “1500 yen” and is the largest (highest), and the buyout price set to the advertising target auction corresponding to the auction ID “004” is the smallest (lowest). It is rarely expected that an advertising target auction of which the buyout price is relatively high will be browsed or purchased by users. Thus, based on the magnitude of the buyout price, an advertisement presentation priority of “Large” is determined for the advertising target auction of the auction ID “004,” for example, an advertisement presentation priority of “Medium” is determined for the advertising target auction of the auction ID “003,” for example, and an advertisement presentation priority of “Small” is determined for the advertising target auction of the auction ID “001,” for example. In this way, the information on an auction of which the set buyout price is relative low is preferentially presented to the bidders who try to bid for the auction of the specific item. According to such a configuration, an authentication which is highly expected to be browsed or purchased can be effectively presented to bidders who try to bid for the auction of the specific item. Further, it is possible to reduce the load on the information processing server SA and the network NW as compared to presenting the information on all advertising target auctions specified in step S5 without discrimination without determining the advertisement presentation priority.

As another example, the advertising target auction presenting unit 45 may determine that the advertisement presentation priority of “Large” is determined for an advertising target auction of which the set advertising rate is relatively high among the plurality of advertising target auctions specified in step S5. In this way, the information on an auction of which the set advertising rate is relatively high is preferentially presented to bidders who try to bid for the auction of the specific item. According to such a configuration, the exhibitor of the advertising target auction can get a profit appropriate for the advertising rate.

Subsequently, the advertising target auction presenting unit 45 of the system control unit 4 executes a presenting process of presenting the information on the advertising target auction specified in step S5 to bidders who try to bid for the auction of the specific item according to the advertisement presentation priority determined in step S8 (step S9). In the advertisement presentation priority-based presenting process, the advertising target auction presenting unit 45 displays the information on the advertising target auction in descending order of the priorities using a web browser, for example, in a state where the webpage for receiving bids for the auction of the specific item, for example, is displayed. For example, the respective windows for displaying the information of the respective advertising target auctions are updated every predetermined period (e.g., 10 seconds) and displayed. Alternatively, the respective windows for displaying the information on the respective advertising target auctions are updated and displayed according to an operation of a user (e.g., whenever a mouse click is received). In this way, it is possible to present the information on the plurality of advertising target auctions so as to be easily seen by the bidders who try to bid for the auction of the specific item (because it is difficult to see the information on the plurality of advertising target auctions if the information is displayed at the same time).

When a bidder has already bid for the advertising target auction specified in step S5, the presenting process may not be performed. In this way, it is possible to prevent the profit of the bidder for the advertising target auction from being harmed.

As described above, according to the embodiment, the information processing server SA specifies an advertising target auction of which at least one the item name and the item code is identical to the item name and/or the item code of a specific item exhibited on an auction and which can be auctioned off at a bid price which has been bid for the auction of the specific item when a bidder who tries to bid for the auction of the specific item via a webpage for receiving bids for an auction is a bidder who has lost the right to win the specific item due to a bid of another bidder and presents the information on the specified advertising target auction to bidders who try to bid for the auction of the specific item. Thus, it is possible to present the information on the advertising target auction at an appropriate point in time (that is, a point in time before bidding for the auction of the specific item) to users (users having an increased desire for bidding) who have a strong desire to purchase the item. Therefore, it is possible to broaden the choice for items to be purchased by the bidders who try to bid for the auction of the specific item. Moreover, it is possible to increase the advertisement effect of the advertising target auction.

The exhibition receiving processor 41 of the system control unit 4 may reset the advertising rate of the advertising target auction specified in step S5 based on the set buyout price. For example, the exhibition receiving processor 41 decreases the advertising rate set for an auction of which the set buyout price is relatively high among the plurality of advertising target auctions specified in step S5. Alternatively, the exhibition receiving processor 41 increases the advertising rate set for an auction of which the set buyout price is relative low among the plurality of advertising target auctions specified in step S5. According to such a configuration, the advertising rate can be automatically adjusted so that the exhibitor of the advertising target auction can get a profit appropriate for the advertising rate paid by the exhibitor.

Moreover, the exhibition receiving processor 41 may acquire the probability (conversion ratio) that an item is purchased by a bidder who tries to bid for the auction of the specific item from the purchase history in the user information database 22, for example, using the bidder ID of the bidder as a key, and reset the advertising rate of the advertising target auction based on the acquired probability (conversion ratio). The lower the probability (conversion ratio) that an item is purchased, the less it is expected that the item exhibited on the advertising target auction is purchased by the bidder. Thus, the exhibition receiving processor 41 decreases the advertising rate of the advertising target auction when the probability (conversion ratio) that an item is purchased by the bidder who tries to bid for the auction of the specific item is equal to or smaller than a threshold. Alternatively, the exhibition receiving processor 41 increases the advertising rate of the advertising target auction when the probability (conversion ratio) that an item is purchased by the bidder who tries to bid for the auction of the specific item is equal to or larger than a threshold. According to such a configuration, the advertising rate can be automatically adjusted so that the exhibitor of the advertising target auction can get a profit appropriate for the advertising rate paid by the exhibitor.

In the embodiment, the information processing server SA is configured to perform the process illustrated in FIG. 4 (that is, the information processing server SA functions as an information processing apparatus of the present invention). However, as another example, the user terminal Tn may function as the information processing apparatus of the present invention to perform the process illustrated in FIG. 4 in cooperation with the information processing server SA. In this configuration, the process is performed based on a program transmitted from the information processing server SA to the user terminal Tn, and the CPU of the user terminal Tn functions as a display controlling means, a specifying means, a presenting means, and the like. In this configuration, the information processing server SA transmits information indicating whether the user (bidder who tries to bid for the auction of the specific item via a webpage for receiving bids for the auction of the specific item) of the user terminal Tn is a bidder who has lost the right to win the specific item in advance to the user terminal Tn. Here, the bidder who tries to bid for the auction of the specific item is a user of which the user ID is specified by the login process. For example, the right information may be transmitted by being included in the webpage data transmitted to the user terminal Tn, and may be transmitted after the webpage data is transmitted.

When the user of the user terminal Tn operates an operation unit to perform an active bidding action, the user terminal Tn determines whether the bidder (the user of the user terminal Tn) who tries to bid for the auction of the specific item via the webpage is a bidder who has lost the right to win the specific item due to a bid of another bidder based on the right information received from the information processing server SA (step S1). When it is determined that the bidder who tries to bid for the auction of the specific item is the bidder who has lost the right to win the specific item due to a bid of another bidder (step S1: YES), the user terminal Tn asks the information processing server SA to determine whether a non-ended advertising target auction (that is, an auction of which the buyout price is set and which is set as an advertising target) of which at least one of the item name and the item code is identical to the item name and/or the item code of the item exhibited on the auction of the specific item is present (step S2). When it is determined in step S2 that the advertising target auction is present (step S2: YES), the user terminal Tn acquires information (e.g., item specification information, a buyout price, a current price, the number of bids, and the like) of the advertising target auction from the information processing server SA (step S3). In step S2, rather than asking the information processing server SA, the user terminal Tn may acquire, from the information processing server SA, the information on the advertising target auction of which the exhibition information includes the item code identical to the item code of the item exhibited on the auction of the specific item in advance (e.g., when acquiring the right information from the information processing server SA). In this case, the user terminal Tn makes the determination of step S2 by referring to the information on the advertising target auction acquired in advance.

Subsequently, the user terminal Tn determines whether an advertising target auction that can be auctioned off at a bid price which has been bid for the auction of the specific item is present in the advertising target auctions acquired in step S3 (step S4). For example, the current price (acquired from the information processing server SA) of the auction of the specific item is compared with the buyout price (acquired in step S3) of the advertising target auction. When the advertising target auction of which the buyout price is equal to or lower than the current price is present, it is determined that the advertising target auction that can be auctioned off at the current bid price is present. Moreover, when it is determined that an advertising target auction that can be auctioned off immediately at the current bid price having been bid for the auction of the specific item is present in the advertising target auctions extracted in step S3 (step S4: YES), the user terminal Tn specifies the advertising target auction which has been determined to satisfy the condition in step S4 (e.g., the advertising target auction is specified by an auction ID). Subsequently, the user terminal Tn determines whether a plurality of advertising target auctions has been specified in step S5 (step S6). When it is determined that a plurality of advertising target auctions has not been specified (that is, only one advertising target auction has been specified) (step S6: NO), the user terminal Tn executes a process of presenting information on the advertising target auction specified in step S5 to bidders who try to bid for the auction of the specific item (step S7). In this presenting process, the user terminal Tn displays the information on the advertising target auction using a web browser in a state where the webpage for receiving bids for the auction of the specific item is displayed, for example. On the other hand, when it is determined that a plurality of advertising target auctions has been specified (step S6: YES), the user terminal Tn determines the advertisement presentation priority of at least some of the plurality of advertising target auctions similarly to information processing server SA (step S8). Subsequently, the user terminal Tn executes a presenting process of presenting the information on the advertising target auction specified in step S5 to bidders who try to bid for the auction of the specific item according to the advertisement presentation priority determined in step S8 (step S9).

### REFERENCE SIGNS LIST

1: Communicating unit
2: Storage unit
3: Input/output interface unit
4: System control unit
5: System bus
Tn: User terminal
SA: Information processing server
NW: Network

1. An information processing apparatus comprising:
at least one memory operable to store program code;
at least one processor operable to read said program code and operate as instructed by said program code, said program code including:
display controlling code that displays a page for receiving bids for an auction of a specific item exhibited from bidders, on a terminal apparatus of the bidder;
specifying code that specifies other auction in which at least one of the item name and the item code of an item exhibited on the auction, and included in information on the auction of the specific item is identical, and in which an immediate successful bid is possible at a bid price that has been bid for the auction of the specific item, from a storage that stores information on an auction in which the buyout price is set, when the bidder who tries to bid for the auction of the specific item via the page is a bidder who has lost the right to win the specific item due to a bid of another bidder; and
presenting code that presents information on the other auction specified by the specifying code, to bidders who try to bid for the auction of the specific item.

2. The information processing apparatus according to claim 1,
wherein when there are a plurality of the other auctions specified by the specifying code, the presenting code presents information on an auction in which the set buyout price is relatively low, preferentially.

3. The information processing apparatus according to claim 1,
wherein the other auction specified by the specifying code is an auction which is set as an advertising target on condition that an exhibitor pays a predetermined advertising rate, and
when there are a plurality of the other auctions specified by the specifying code, the presenting code presents information on an auction in which the advertising rate of the other auction specified as an advertising target is relatively high, preferentially.

4. The information processing apparatus according to claim 1,
wherein the other auction specified by the specifying code is an auction which is set as an advertising target on condition that an exhibitor pays a predetermined advertising rate,
the information processing apparatus further comprising:
acquiring code that acquires information indicating a probability that an item is purchased by a bidder who tries to bid for the auction of the specific item; and
resetting code that resets an advertising rate of the other auction set as the advertising target based on the probability indicated by the information acquired by the acquiring code.

5. The information processing apparatus according to claim 1,
wherein the other auction specified by the specifying code is an auction which is set as an advertising target on condition that an exhibitor pays a predetermined advertising rate,
the information processing apparatus further comprising:
resetting code that resets an advertising rate of an auction based on the set buyout price when there are a plurality of the other auctions specified by the specifying code.

6. An information processing method, which is executed by a computer, the information processing method comprising:
displaying a page for receiving bids for an auction of a specific item exhibited from bidders, on a terminal apparatus of the bidder; and
specifying, by at least one processor, other auction in which at least one of the item name and the item code of an item exhibited on the auction, and included in information on the auction of the specific item is identical, and in which an immediate successful bid is possible at a bid price that has been bid for the auction of the specific item, from a storage that stores information on an auction in which the buyout price is set, when the bidder who tries to bid for the auction of the specific item via the page is a bidder who has lost the right to win the specific item due to a bid of another bidder; and
presenting information on the other auction specified by the specifying operation, to bidders who try to bid for the auction of the specific item.

7. (canceled)

8. A non-transitory computer readable medium having stored there on program code for performing an information processing method, said program code comprising:
display controlling code that displays a page for receiving bids for an auction of a specific item exhibited from bidders, on a terminal apparatus of the bidder;
specifying code that specifies other auction in which at least one of the item name and the item code of an item exhibited on the auction, and included in information on the auction of the specific item is identical, and in which an immediate successful bid is possible at a bid price that has been bid for the auction of the specific item, from a storage that stores information on an auction in which the buyout price is set, when the bidder who tries to bid for the auction of the specific item via the page is a bidder who has lost the right to win the specific item due to a bid of another bidder; and
presenting code that presents information on the other auction specified by the specifying code, to bidders who try to bid for the auction of the specific item.
